(19) United States
(12) Patent Application Publication
(10) Pub. No.: US 2014/0011290 A1
(43) Pub. Date: Jan. 9, 2014

(54) COLLECTION OF LIQUID ANALYTICAL SAMPLES FOR CLINICAL ANALYTICAL PURPOSE AND DEVICE THEREOF

(71) Applicant: Roche Diagnostics Operations, Inc., Indianapolis, IN (US)

(72) Inventors: Louis-Pierre Gagnaux, Mettmenstetten (CH); Gerhard Veen, Cham (CH)

(73) Assignee: Roche Diagnostics Operations, Inc., Indianapolis, IN (US)

(21) Appl. No.: 14/026,692

(22) Filed: Sep. 13, 2013

Related U.S. Application Data
(63) Continuation-in-part of application No. 12/500,165, filed on Jul. 9, 2009, now abandoned.

(30) Foreign Application Priority Data
Jan. 16, 2007 (EP) 07000762.0
Jan. 15, 2008 (EP) PCT/EP2008/050394

(51) Int. Cl. G01N 1/34

(52) U.S. Cl. CPC G01N 1/34
USPC 436/177; 436/180; 422/501

(57) ABSTRACT

A method and analytical device for collecting a sample volume containing at least one analyte of interest from a liquid analytical sample having contaminants disposed at or near the sample surface. The liquid analytical sample is provided. A first pipetting device comprising a first pipetting needle aspirates from an upper region of the liquid analytical sample a portion comprising the contaminants and discards the portion. The first needle is washed with washing liquid. A second pipetting device comprising a second pipetting needle, or a disposable pipetting tip, aspirates the sample volume from the liquid analytical sample after the first pipetting device discards the aspirated portion and discharges the sample volume for analysis. The second needle is washed with washing liquid or disposed of.

### CROSS-REFERENCE TO RELATED APPLICATIONS

This application is a continuation-in-part of U.S. application Ser. No. 12/500,165 filed Jul. 9, 2009, which claims priority to International Application No. PCT/EP2008/050394 filed Jan. 15, 2008, which claims priority to EP Application No. 07000762.0, filed Jan. 16, 2007.

### TECHNICAL FIELD

Embodiments of the present disclosure refer generally to analytical testing, and, in particular, to a method for collecting a sample volume comprising at least one analyte of interest from a liquid analytical sample having undesired contaminants disposed at or near the sample surface and an analytical device for the collection of the sample volume.

### BACKGROUND

Testing of blood samples, being provided in plasma-tubes such as lithium-heparin plasma-tubes and the like suffer from the disadvantage, that duplicate errors in measurement of e.g. lactate dehydrogenase may be observed which is, of course, unacceptable.

The reason for the errors can be the presence of cell aggregates, the presence of silicon-based surfactants of polypropylene oxide, which are used as coatings for the interior tube-wall, silicon oils, which are used at the phlebotomy device to collect the blood from a patient, additives to prevent the formation of thrombocytes, separation gel residues, and the like. Furthermore, stoppers of tubes may also be coated with lubricant to facilitate their removal and to maintain the lower pressure inside the, for example, evacuated tubes. Surfactants are also a common component of many immunoassays. They are used to decrease or illuminate non-specific absorption, improve stability of the reactions or modify the solid-phase surface to render it less hydrophobic and thus minimize loss of non-convalently bound antibody inclusion of surfactants in immunoassay regions. Especially affected from the reported drawbacks are analytes such as Na, K, LDH (lactate dehydrogenase), ALP (alkaline phosphatase), Ca and total proteins. The errors which are observed are:
1. A too low or a too high aspirated sample volume, what leads to a wrong recovery of the analyte (especially observed at absorbance tests due to the low volume of the samples, typically 2 to 5 μl).
2. Deposition of fibrin and/or “silicon oil” at various device parts (pipetting needle, ISE mixing towers, and the like).

As a result a modified method is proposed in the art with a pre-dilution step to minimize duplicate errors by diluting the sample in saline and then re-sampling, see Clinical Chemistry 50, No. 12, 2004, p. 2391-92. This reduces the risk of re-aspirating the same micro-clots that may have been aspirated in the primary sampling. However, the potential for inaccuracies with the actual primary sampling as a result of micro-clots are not eliminated, even if the duplicate readings are within expected limits. In addition, the amount of required plasma material is higher and the throughput of the system, expressed in test results per hour, goes down.

Furthermore, there is the possibility of serum samples to substantially reduce duplicate errors and the differences between duplicate readings would not be considered clinically significant.

Therefore, there is a need to improve the results of measurements and to reduce the risk of duplicate errors at the analysis of liquid analytical chemistry samples such as, for example, blood plasma samples, while keeping the labor and time effort for the analytical process at a low and reasonable level.

### SUMMARY

The present disclosure refers to a method for collecting a sample volume containing at least one analyte of interest from a liquid analytical sample having undesired contaminants disposed to a large extent at or near the sample surface. The liquid analytical sample comprising the at least one analyte of interest and the undesired contaminants is provided. A first pipetting device comprising a first reusable pipetting needle aspirates from an upper region of the liquid analytical sample a portion of the liquid analytical sample comprising the undesired contaminants and discards the aspirated portion using the first reusable pipetting needle. The first reusable needle is washed with washing liquid. A second pipetting device comprising a second reusable pipetting needle, or a disposable pipetting tip, aspirates the sample volume from the liquid analytical sample after the first pipetting device discards the aspirated portion and discharges the sample volume for analysis. The second reusable needle is washed with washing liquid or the tip is disposed of.

In accordance with one embodiment of the present disclosure, an analytical device for the collection of a sample volume comprising at least one analyte of interest from a liquid analytical sample having undesired contaminants disposed to a large extent at or near the sample surface is disclosed. The analytical device comprises a first pipetting device comprising a reusable pipetting needle which aspirates from an upper region of the liquid analytical sample a volume of the liquid comprising the undesired contaminants to be discarded and discards the volume of liquid, the needle being washable; and a second pipetting device comprising a second reusable pipetting needle or a disposable pipetting tip, which aspirates a sample volume of from the liquid analytical sample after aspiration of the volume of liquid comprising the undesired contaminants by the first pipetting device.

Accordingly, it is a feature of the embodiments of the present disclosure to improve the results of measurements and to reduce the risk of duplicate errors at the analysis of liquid analytical chemistry samples such as, for example, blood plasma samples, while keeping the labor and time effort for the analytical process at a low and reasonable level. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates schematically and step-by-step a possible layout of the sampling procedure according to an embodiment of the present disclosure.

FIG. 2 illustrates schematically a further possible layout of the sampling procedure according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A method for the collection of a liquid analytical sample, comprising at least one analyte of interest is presented. In particular, the removal of application interfering compounds as undesired contaminants disposed at or near the sample surface and analysis of various clinical chemistry analytes, primarily from lithium-heparin tubes is disclosed. Additionally, an analytical device for the collection of a liquid analytical sample comprising at least one analyte of interest is presented.

A technical solution comprises in collecting prior to the first effective volume collection of a liquid analytical sample, comprising at least one analyte of interest, at least one first portion in advance, this first sample in advance being collected from the surface area, just underneath or at a distance from the surface of the liquid analyte sample for being disposed separately. After sampling this first portion in advance the effective volume collection takes place using a different aspirating device such as a pipetting needle. In particular, in one embodiment, the method comprises the steps of
a) providing a liquid analytical sample, comprising at least one analyte of interest,
b) providing a first pipetting device, comprising a first reusable pipetting needle,
c) aspirating by said first pipetting device a portion of the liquid sample from the surface area, comprising undesired contaminants and discarding said portion,
d) washing said first reusable needle with washing liquid,
e) providing a second pipetting device, comprising a second reusable pipetting needle or a pipetting device with a disposable pipetting tip,
f) aspirating a volume of liquid analytical sample by said second pipetting device,
g) discharging said volume of analytical sample for being analysed, and
h) washing said second reusable needle with washing liquid or disposing the disposable tip of said pipetting device.

In other words, before pipetting the first regular volume of liquid analytical sample, a defined portion can be pipetted in advance from the sample surface, just underneath or at a distance from the surface by using a first pipetting device comprising a first reusable pipetting needle. This first portion in advance being discharged afterwards and not used for analytical purpose. This so called “dummy pipetting” can be discharged e.g. in a waste container. The depths of the needle for the removal of the first volume in advance is of course dependent upon the presence of any components or elements, which could interfere with the analysis and which are typically present in the upper region i.e. near the surface of the sample to be analyzed. These interfering components or elements are called contaminants. Examples of these contaminants are cell aggregates, droplets or suspensions of silicone oils, mineral oils, lubricants, or the like, additives to prevent the formation of thrombocytes, surfactants, fibrin clots.

After this so called “dummy pipetting,” the effective volume collection of liquid analytical sample can take place by using a second pipetting device comprising a second reusable pipetting needle or a pipetting device comprising a disposable pipetting tip. The second volume to be collected is typically smaller than the first volume aspirated during the first portion collection. A typical volume being collected for analytical purpose is <10 μl, often about 2 to about 5 μl.

Within the present invention, no separation reagent is added to separate the sample to be analyzed from contaminants. A liquid analytical sample according to the present invention is the liquid component of an analytical body fluid, typically blood, comprising one or more analytes of interest. An example of liquid analytical sample is plasma separated from the non-liquid or particulate component of blood such as red blood cells. The non-liquid or particulate component of a blood sample may still be present in the sample tube, at the bottom, e.g. after sedimentation or centrifugation.

According to one embodiment, the analytes of interest are typical analytes of clinical chemistry tests and which are homogeneously distributed in the liquid analytical sample. This means that the liquid analytical sample at the moment of pipetting and being analyzed typically consists, at least to a large extent, of a liquid monophase or layer. Examples of analytes of interest are Na, K, LDH, ALP, Ca, total proteins, etc.

Positioning of the pipetting device with respect to the sample surface does not have to be precise, i.e., it has not to be done at an exact distance from the sample surface, meaning within a very narrow and distinct layer. As a result, the analytical process according the present invention is easy and can be automated, but nevertheless ensuring reliable results.

In order to further optimize the process, it is proposed to first insert a certain volume of washing liquid, e.g. water, into the reusable pipetting needles before collecting volumes of sample. By first inserting a certain wash liquid volume into the needle, traces of the previous sample can be washed away when or after discharging the sample volume, and the needle can be cleaned before the next use. This of course can be important for not contaminating the next sample, when the same first pipetting device is used again for collecting the first portion in advance at the next e.g. plasma tube. The effective volume of liquid analytical sample can be collected by a second device as e.g. a pipetting device, the amount of the effective volume being lower than the volume of the first portion in advance. This effective volume can now be used for analytical purpose for the determination of the respective analytes of interest. The analytical process as such is well-known in the art and shall not be described at this stage. In one embodiment, the reusable needle is also washed from the outside by using a washing liquid and for this a washing unit can be provided.

In one embodiment, a certain volume of separating phase is also introduced into the reusable needle for separating the washing liquid from the aspirated portion or sample volume. This may help to prevent contamination and/or dilution of the liquid analytical sample with wash liquid. According to one embodiment, this separating phase is an air plug.

Furthermore, an analytical device for the collection of a liquid analytical sample, comprising at least one analyte of interest, is proposed. This analytical device could be e.g. a device for pipetting volumes of samples from e.g. lithium-heparin plasma tubes.

The analytical device comprises at least two sample-collecting or pipetting devices, one pipetting device being used for collecting a first portion in advance, and a second sample device for collecting the effective analytical volume to be analytically determined in a following process step.

Furthermore, in one embodiment, the device comprises a washing unit for washing the pipetting needles also from the outside.

In particular, according to one embodiment, an analytical device for the collection of a liquid analytical sample, comprising at least one analyte of interest, is proposed, the liquid analytical sample comprising undesired contaminants disposed to a large extent at or near the surface. The device comprises a first pipetting device, comprising a reusable pipetting needle, the needle being washable, for aspirating from the surface area a volume of the liquid sample comprising the undesired contaminants to be discharged and a second pipetting device, comprising a second reusable pipetting needle or a disposable pipetting tip, the needle being washable for aspirating a volume of analytical sample to be analyzed.

As already described above, for washing the pipetting needle, it is possible to first introduce a certain amount of a washing liquid before collecting any of the samples. This can be done e.g. within a washing unit for inserting into that reusable needles a certain amount of washing liquid. In addition or alternatively it is also possible to wash the needles from the outside within the mentioned washing unit.

The analytical device may comprise tube-like containers for the arrangement of one or a plurality of liquid analytical samples to be processed. It is further proposed to arrange a rack for receiving a plurality of tube-like reagent containers.

Furthermore, it is possible to arrange cuvettes at the analytical device for mixing analytical liquid samples with reagents for analysis.

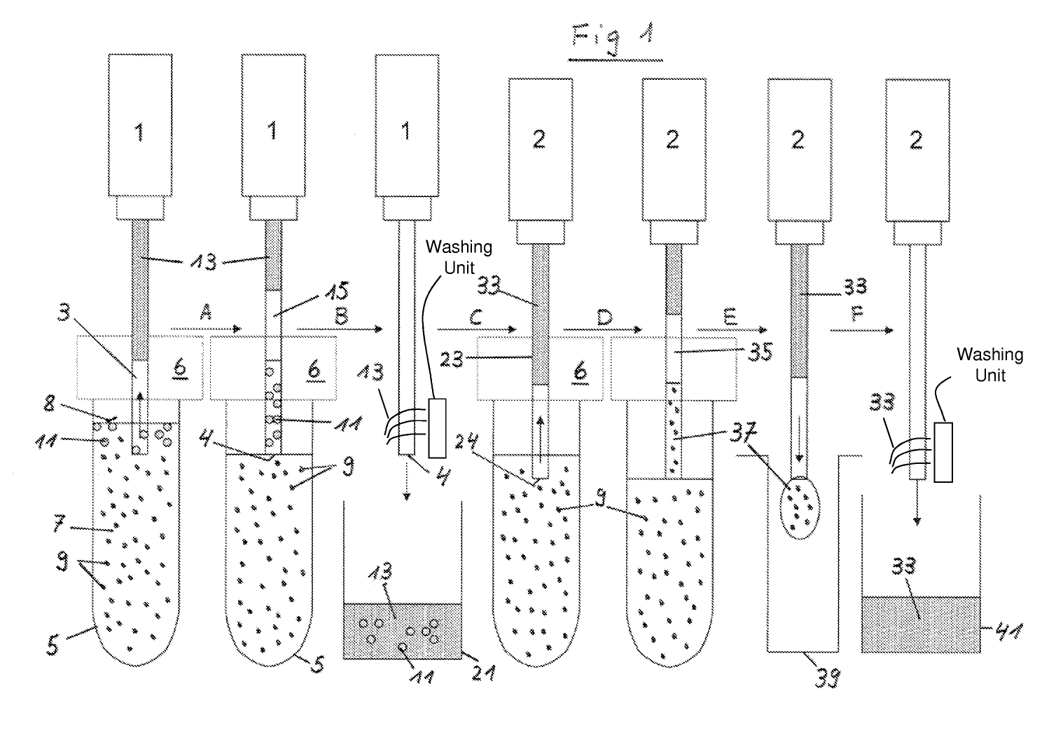

Referring to FIG. 1, a pipetting device 1 including a pipetting needle 3 is inserted through a cover 6 of a sample tube 5 into a liquid analytical sample 7. Within the liquid analytical sample 7, at least one analyte 9 of interest is homogeneously distributed. In the area of the surface 8 of the analytical sample 7 contaminants 11 are present. Within the needle 3 of the pipetting device 1, a washing liquid 13 is arranged.

In a first step A), a first portion is aspirated through the needle-tip 4 into the needle 3, containing the contaminants 11. While inserting the first portion, an air plug 15 occurs between the washing liquid 13 and the first portion.

In a successive step B), the pipetting device 1 is removed from the sample tube 5 and is transported to a waste container 21, where the first portion, comprising the contaminants 11, is disposed, together with the washing liquid 13. In other words, at the same time during step B), the first portion is disposed and the collecting needle 3 is cleaned by the washing liquid.

In a successive step C), a second pipetting device 2 is inserted through the top cover 6 into the liquid analytical sample 7, arranged within the sample tube 5. Within the collecting needle 23 of the pipetting device 2, again a washing liquid 33 is arranged.

In a following step D), a second volume 37 is aspired into the collecting needle 23 via the needle-tip 24.

In the following step E), the pipetting device 2 is transported to a cuvette for analysis 39, where the second sample volume 37 is disposed for analytical purpose.

In a successive step F), the second pipetting device 2 is further transported to a waste container 41, where the collecting needle 23 is cleaned by disposing the washing liquid 33. Being cleaned, the second pipetting device 2, together with the pipetting needle 23, can be reused for a further volume collecting step.

From the inserted plasma sample tubes, before the first regular sample volume pipetting step only once a defined first portion in advance such as e.g. 100 μl shall be collected. Of course the sample portion to be precollected is dependent upon the total volume within the plasma sample tube. After collection of the first sample portion, the pipetting device shall be removed from the plasma sample tube and arranged at a washing device as e.g. a washing unit. As before executing the pipetting process a certain amount of wash water as explained has been included into the pipetting needle, so that the pre-collected sample can be disposed into a waste container and at the same process step the inside of the pipetting needle is washed with the washing liquid, which is arranged above the precollected sample. Furthermore the needle is washed within the washing tower to be ready for a further precollecting step at the next plasma tube.

With a second pipetting device, the effective volume of liquid analytical sample to be analyzed can be collected from the sample tube using a pipetting needle. The sample volume is typically smaller than the volume of the pre-collected sample. Sample volumes for analytical biochemical purposes e.g. of blood plasma samples can be in the range between 2 and 10 μl, typically 2 to 5 μl. In particular, the second pipetting device can be optimized for pipetting in this smaller volume range compared to the first pipetting device so that higher pipetting precision can be obtained when pipetting the effective volume of sample for Analysis. Additionally, due to the fact that most of the possible contaminants are removed, it can be expected that within the effective collected liquid analytical sample practically no or negligible amounts of contaminants are present which could affect the analytical result and the effective volume of sample aspirated. In other words, it can be expected that so called duplicate errors may not occur anymore by using the inventive proposed two-step pipetting process as described above.

After collection of the analytical sample volume it can be injected e.g. into a respective analytical arrangement for executing the analysis process, which is known in the art and is not described in details at this stage.

Of course dependent of the kind of tube, the tube volume and the type of analysis to be executed, the volume of the pre-collected first portion in advance, the depths of the needle tip may vary as well as the volume of the effective volume, being collected in the second step.

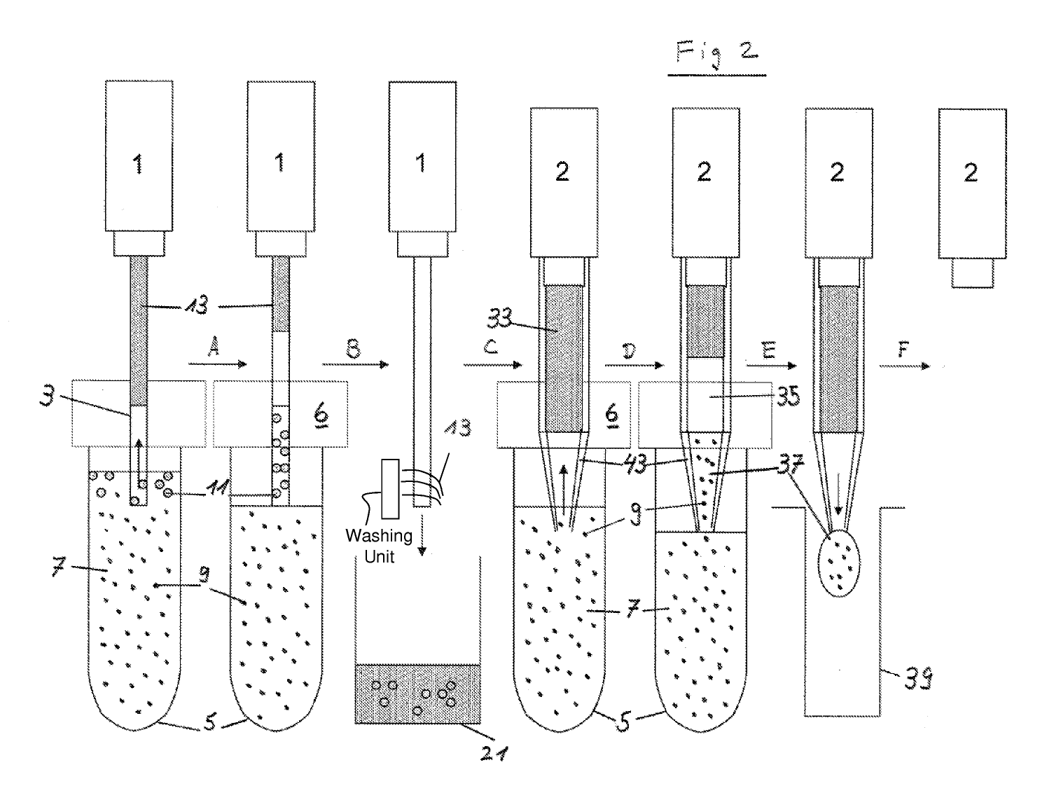

In FIG. 2, again schematically and step-by-step, a very similar layout of the inventive process is described, with the difference that at the second pipetting device, a disposable pipetting tip 43 is arranged. In other words, step A) and B) are equivalent to the respective steps in FIG. 1. At step C), a new pipetting tip 43 has to be arranged for the further collection of the liquid sample volume 37, which is collected in step D).

In the following step E), again the pipetting device 2 is transported to a cuvette for analysis 39, where the second sample volume 37 is disposed. In the following step F), no washing of the needle 43 is necessary, as it can be simply disposed and not used anymore for a further collection of sample volumes.

Of course, the same is also possible with pipetting device 1, where also a disposable pipetting needle can be used.

After the effective sampling process further effective samples may be collected e.g. for other tests. Further collections may be executed.

In an exemplary embodiment, the amount, or volume, of the liquid analytic sample 7 that the pipetting devices 1, 2 aspirate can be different. For example, the first pipetting device 1 can aspirate a much larger volume of the liquid analytic sample 7 than the second pipetting device 2. In one embodiment, for example, the first pipetting device 1 can aspirate approximately 100 μl from the liquid analytic sample 7. In contrast, the second pipetting device 2 can aspirate approximately 2 to approximately 10 μl from the liquid analytic sample 7. The ability to adapt the aspiration volumes that the first and second pipetting devices 1, 2 can aspirate from the liquid analytic sample 7 can optimize the pipetting precision of the analytical device process.

In an exemplary embodiment, the analytical device can comprise two separate pipetting devices 1, 2. In one embodiment, the first pipetting device 1 can be used for aspirating and discharging the contaminants 11 on or near the surface 8 of the liquid analytical liquid 7 and the second pipetting device 2 can be used for aspirating the sample volume 37 to be used for the analysis of the at least one analyte of interest 9 in the liquid analytical sample 7. For example, the first pipetting device 1 can aspirate the contaminants 11 from the upper surface 8 of the liquid analytic sample 7 via the first pipetting needle 3. After the first pipetting needle 3 has been removed from the liquid analytic sample 7, the collecting, or second, pipetting needle 23 of the second pipetting device 2 can start to aspirate the sample volume 37 without waiting for the first pipetting needle 3 of the first pipetting device 1 to be washed and/or replaced, thereby, increasing the throughput of the analytical device process. While the second pipetting device 2 is aspirating the sample volume 37, the first pipetting device 1 can also concurrently discard the contaminants 11 into the waste container 21.

It can also be envisioned that the first and second pipetting device 1, 2 can also be adapted to aspirate different volumes from the liquid analytic sample 7 in order to optimize the pipetting precision as well as increasing the throughput of the system.

FIGS. 1 and 2, as well as the respective description, are only showing and mentioning examples for further explaining the present invention. The invention of course is not at all limited to the figures and the respective descriptions. Furthermore, different kinds of tubes or containers with or without closures may be used to provide e.g. blood samples for analytical purpose. The first sample portion collection could happen e.g. more or less directly from the surface layer, could be done just beneath the surface layer or could be executed at a distance from the surface layer dependent upon the range or area, in which the non-desired and interfering components and elements are present within the sample to be analysed.

In addition the present invention is not limited to analytical samples as described in respect to the drawings and the examples but can be used for any kind of liquid analytical samples to be collected for analytical purpose.

We claim:

1. A method for the collecting a sample volume comprising at least one analyte of interest from a liquid analytical sample having contaminants disposed at or near the surface, wherein the liquid analytical sample comprises a liquid mono-phase and wherein the at least one analyte is homogeneously distributed in the liquid analytic sample, the method comprising:
providing a first pipetting device comprising a first pipetting needle which aspirates from an upper region of the liquid analytical sample a first portion of the liquid analytical sample comprising the contaminants and discards the first portion into a waste container; and
providing a second pipetting device comprising a second pipetting needle or disposable tip which aspirates a sample volume from the liquid analytical sample after the first pipetting device aspirates the aspirated portion of the liquid analytic sample and discharges the sample volume into a cuvette for analysis, wherein the second pipetting device aspirates the sample volume from the liquid analytical sample while the first pipetting needle is concurrently being washed, and wherein the second pipetting device aspirates a smaller volume of the liquid analytical sample than the first pipetting device.

2. The method according to claim 1, further comprising,
washing the first pipetting needle and the second pipetting needle with washing liquid.

3. The method according to claim 2, wherein washing the first pipetting needle and the second pipetting needle comprises inserting a volume of washing liquid into the first pipetting needle and the second pipetting needle before aspirating the portion of the liquid analytical sample.

4. The method according to claim 3, wherein washing the first pipetting needle and the second pipetting needle further comprises inserting a separating phase volume into the first pipetting needle and the second pipetting needle for separating the washing liquid from the aspirated portion of liquid analytical sample.

5. The method according to claim 4, wherein the separating phase volume is an air plug.

6. The method according to claim 3, wherein washing the first pipetting needle and the second pipetting needle occurs after discharging by passing and discharging the inserted volume of washing liquid through the part of the first pipetting needle and the second pipetting needle which was occupied by the portion of the liquid analytical sample.

7. The method according to claim 2, wherein washing the first pipetting needle and the second pipetting needle further comprises washing the first pipetting needle and the second pipetting needle from the outside with washing liquid provided from a washing unit.

8. The method according to claim 1, wherein the liquid analytic sample is a body fluid.

9. The method according to claim 1, wherein the at least one analyte of interest is a clinical chemistry analyte.

10. The method of claim 2, wherein the washing of the first reusable needle with washing liquid occurs at the same time the aspirated portion of the liquid analytical sample is discarded from the first pipetting needle.

11. An analytical device for the collection of a sample volume comprising at least one analyte of interest from a liquid analytical sample having contaminants disposed at or near the sample surface, wherein the liquid analytical sample comprises a liquid mono-phase or layer and wherein the at least one analyte is homogeneously distributed in the liquid analytical sample, the analytical device comprising:
a first pipetting device comprising a pipetting needle which aspirates from an upper region of the liquid analytical sample a volume of liquid comprising the contaminants and discards the volume of liquid;
a second pipetting device comprising a second pipetting needle or a disposable pipetting tip configured to aspirate a smaller volume of liquid volume of the liquid analytical sample than the first pipetting device and to aspirate the sample volume from the liquid analytical sample after aspiration of the volume of liquid comprising the contaminants by the first pipetting device; and
wherein the second pipetting device is configured to aspirate the sample volume of the liquid analytical sample while the first pipetting needle is being washed.

12. The analytical device according to claim 11, further comprising,
tube-like containers comprising one or a plurality of liquid analytical samples to be processed.

13. The analytical device according to claim 11, further comprising,
racks for receiving reagent containers.

14. The analytical device according to claim 13, further comprising,
cuvettes for mixing analytical liquid samples with reagents for analysis.

15. The analytical device according to claim 11, further comprising,
a washing unit having a washing fluid that washes an exterior of the first pipetting needle and an interior of the first pipetting needle at the same time the aspirated volume of liquid is discarded from the first pipetting needle by the first pipetting device.

16. A method for the collecting a sample volume comprising at least one analyte of interest from a liquid analytical sample having contaminants disposed at or near the surface, wherein the liquid analytical sample comprises a liquid mono-phase or layer and wherein the at least one analyte is homogeneously distributed in the liquid analytic sample, the method comprising:
providing an analytical device having both a first pipetting device comprising a first pipetting needle and a second pipetting device comprising a second pipetting needle or disposable tip;
providing to the analytical device the liquid analytical sample comprising at least one analyte of interest and the contaminants;
aspirating with the first pipetting device via the first pipetting needle positioned in an upper region of the liquid analytical sample, a portion of the liquid analytical sample comprising the contaminants;
discharging the aspirated portion from the first pipetting needle;
washing the first pipetting needle with washing liquid;
aspirating a sample volume with the second pipetting device via the second pipetting needle or disposable tip positioned in a remaining volume of the liquid analytical sample;
discharging from the second pipetting needle or disposable tip the sample volume into a cuvette of an analysis device for analysis, wherein the second pipetting device aspirates and discharges the sample volume from the liquid analytical sample while the first reusable pipetting needle is concurrently being washed, and wherein the second pipetting device aspirates a smaller volume of the liquid sample than the first pipetting device; and
washing, after discharging the sample volume into the cuvette, the second pipetting needle with washing liquid or disposing the disposable tip.

17. The method according to claim 16, when aspirating, discharging and washing are performed automatically by the analytic device.

18. The method according to claim 16, further comprises,
inserting both a volume of washing liquid and a separating phase volume into the pipetting needle of at least the first pipetting device before aspirating, wherein washing comprises discharging the washing liquid and the separating phase volume from the pipetting needle.

19. The method according to claim 18, wherein the washing of the first pipetting needle with the washing liquid is at the same time the aspirated portion of the liquid analytical sample is discarded from the first pipetting needle.
